(19) United States
(12) Patent Application Publication
(10) Pub. No.: US 2013/0335218 A1
(43) Pub. Date: Dec. 19, 2013

(54) Apparatus and Method of Preventing Flooding in Residential and Commercial Properties

(71) Applicant: Andrew Jones, Roanoke, TX (US)

(72) Inventor: Andrew Jones, Roanoke, TX (US)

(21) Appl. No.: 13/918,377

(22) Filed: Jun. 14, 2013

Related U.S. Application Data
(60) Provisional application No. 61/659,973, filed on Jun. 14, 2012.

(51) Int. Cl. G08B 21/18

(52) U.S. Cl. CPC G08B 21/182
USPC 340/539.1; 340/605

(57) ABSTRACT

The present application is directed to a system and method for detecting a leak in a fluid line. The system includes a plurality of sensors to measure fluid flow in the fluid lines. Additionally the system includes a control module configured to continuously monitor fluid flow entering and leaving the fluid system to detect the leak, the control module regulates fluid flow in the fluid system by comparing fluid use at the point of use sensor to fluid use at the point of entry sensor. The system detects a leak by comparing fluid flow between the point of use and the point of entry. The system can notify a user of potential leaks and selectively control valves to regulate fluid flow.

### BACKGROUND

1. Field of the Invention

The present application relates generally to leak detection and, more particularly, a control system for detecting leaks in a residential structure.

2. Description of Related Art

Leaks in homes cause extensive damages and may result in excessive repair costs each year. Typically detection of a leak is done through visual inspection, the liquid itself or the damage from the liquid. Reliance upon visual detection is not adequate because usually the evidence of a leak is visible only after the leak has been occurring for a length of time and damage has been done. The longer a leak occurs, typically the more damage may be caused. Reliance upon visual indication is generally too slow to catch a leak before the leak results in significant repairs.

Some devices have been introduced to attempt to detect a leak quickly. One system uses a device such as a wet sensor located in selected areas. If the wet sensor detects water, a leak is identified. A disadvantage of this system is that a wet sensor is location specific and leaks may occur at any point within the fluid line. Another device relies upon time of use to detect a leak. For example, if water is running for a certain duration of time, then there must be a leak. A disadvantage to a system with this device is that the leak remains undetected during that permitted time duration, resulting in potentially more damage. Another system uses a device that relies upon a pressure drop in the fluid line. A disadvantage of this system is that pressure drops can be experienced for any number of reasons in a residential home or other use. Slow leaks may not create a significant pressure loss in the fluid line to trigger detection. If the system tightly controlled the pressure drops then there may exist false detections as pressure fluctuations exist during natural use of the water system.

A new system that is capable of detecting leaks throughout the entire fluid line accurately is needed. Although great strides have been made in leak detection, considerable shortcomings remain.

### DESCRIPTION OF THE DRAWINGS

The novel features believed characteristic of the application are set forth in the appended claims. However, the application itself, as well as a preferred mode of use, and further objectives and advantages thereof, will best be understood by reference to the following detailed description when read in conjunction with the accompanying drawings, wherein:

FIG. 1 is a schematic of a leak detection system according to the preferred embodiment of the present application.

While the system and method of the present application is susceptible to various modifications and alternative forms, specific embodiments thereof have been shown by way of example in the drawings and are herein described in detail. It should be understood, however, that the description herein of specific embodiments is not intended to limit the application to the particular embodiment disclosed, but on the contrary, the intention is to cover all modifications, equivalents, and alternatives falling within the spirit and scope of the process of the present application as defined by the appended claims.

### DETAILED DESCRIPTION OF THE PREFERRED EMBODIMENT

Illustrative embodiments of the preferred embodiment are described below. In the interest of clarity, not all features of an actual implementation are described in this specification. It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

In the specification, reference may be made to the spatial relationships between various components and to the spatial orientation of various aspects of components as the devices are depicted in the attached drawings. However, as will be recognized by those skilled in the art after a complete reading of the present application, the devices, members, apparatuses, etc. described herein may be positioned in any desired orientation. Thus, the use of terms to describe a spatial relationship between various components or to describe the spatial orientation of aspects of such components should be understood to describe a relative relationship between the components or a spatial orientation of aspects of such components, respectively, as the device described herein may be oriented in any desired direction.

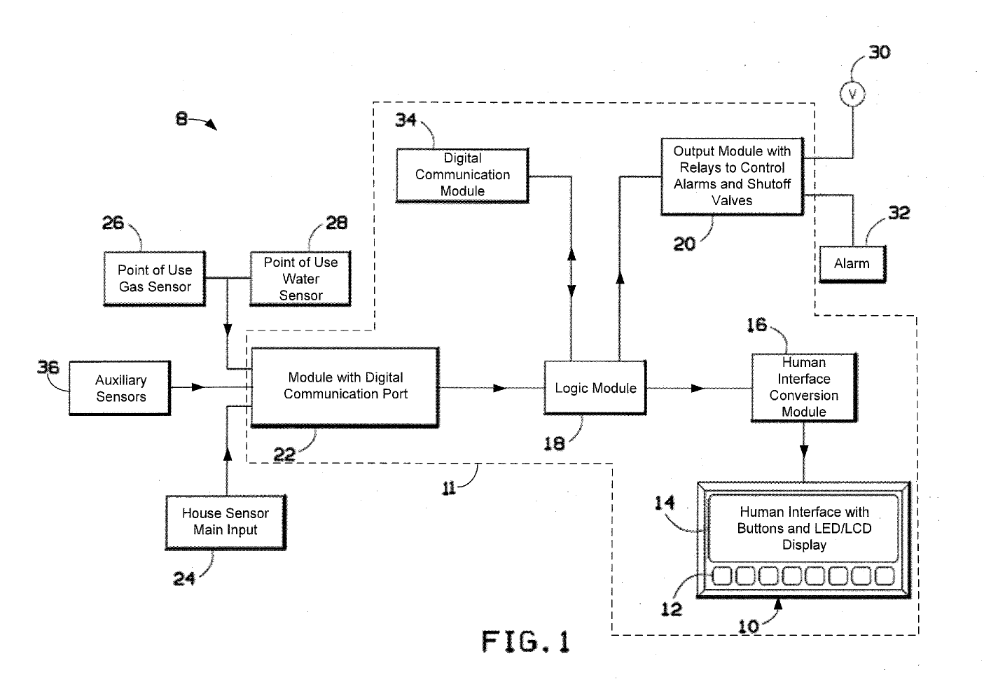

Referring now to FIG. 1 in the drawings, a schematic of a leak detection system 8 is illustrated. System 8 includes one or more sensors in communication with an electronic device configured to analyze and recognize the presence of at least any of the following: airborne elements, fluid flow in fluid lines, vibrations, and noise within a given vicinity. In particular, system 8 is located within a structure, such as a building, and is coupled to the fluid system. The fluid system refers to any number of pipes, hoses, and/or tubes used to contain, store, and/or transport a fluid, such as a liquid and/or a gas. For example, the fluid system may refer to the water pipes within a residential or commercial structure. Additionally, the fluid system may refer to the gas lines within a residential or commercial structure. System 8 is configured to monitor and compare fluid flow at the point of use to that of fluid flow at the point of entry to isolate and detect a leak in the fluid system.

System 8 includes one or more sensors in communication with the fluid system of a structure. In the preferred embodiment, system 8 is configured to detect a leak in the fluid lines by calculating the differential between approved fluid flow at the point of use with fluid flow at the point of entry. The approved point of use is described as being where the fluid leaves the fluid lines. In the present application, the approved point of use is preferably a fluid use device, such as a faucet, fridge, dishwasher, washer, dryer, water heater and stove for example. In general, the approved point of use is the location where the fluid exits the fluid lines to enter a fluid use device or the eternal environment (i.e. an exterior hose bib). The point of entry is described as one or more locations that provide fluid to the structure within one or more fluid lines. The fluid enters the structure through the point of entry. An example of a point of entry is the water main to a home.

The sensors of system 8 include fluid sensors configured to continuously monitor fluid flow (flow rate and usage for example) through each approved point of use and at the point of entry. System 8 includes a point of entry sensor 24 located in communication with the fluid lines entering the structure. System 8 also includes a point of use sensor (26, 28) in communication with the fluid lines terminating within or external to the structure. The point of use sensor (26, 28) is preferably located adjacent the point of consumption, for example, at the fluid use device. In a residential structure, point of use sensor (28, 26) is located between fluid use device and the fluid lines of the structure. For example, if the point of use sensor 28 were used in communication with a sink, point of use sensor 28 would be located between fluid lines exiting the wall of the structure and the sink. Additionally, if point of use sensor 26 were used in communication with a stove, point of use sensor 26 would be located between the gas lines and the stove. It is understood that the location of sensors 26, 28 may be altered to any point along the fluid lines.

System 8 may be used with one or more sensors 26 and/or sensors 28. Additionally, system 8 is configured to selectively use one or more auxiliary sensors 36. Sensors 36 may be used in communication with a fluid, such as a liquid or gas, as seen with sensors 26, 28. For example, sensor 36 may be a water sensor. However, sensors 36 may also be configured to detect temperature, noise, vibration, airborne particles and so forth. Examples of sensor 36 are a carbon monoxide sensor and a smoke detector. Sensors 36 are preferably coupled to portions of the structure. Sensors 26, 28, and 36 continuously collect data and communicate that data to the electronic device.

System 8 includes an electronic device, such as a control module 11, to receive and transmit data from sensors 26, 28, 36. Control module 11 has an interface 10 and at least one or more of a logic module 18, a sensing module 22, an output module (action module) 20, digital communication module 34, and a digital conversion module 16. Various embodiments of control module 11 can include one or more computers that include one or more processors and memories configured for performing tasks described herein below. This can include, for example, a computer having a central processing unit (CPU) and non-volatile memory that stores software instructions for instructing the CPU to perform at least some of the tasks described herein. This can also include, for example, two or more computers that are in communication via a computer network, where one or more of the computers include a CPU and non-volatile memory, and one or more of the computer's non-volatile memory stores software instructions for instructing any of the CPU(s) to perform any of the tasks described herein. Thus, while the exemplary embodiment is described in terms of a discrete machine, it should be appreciated that this description is non-limiting, and that the present description applies equally to numerous other arrangements involving one or more machines performing tasks distributed in any way among the one or more machines. It should also be appreciated that such machines need not be dedicated to performing tasks described herein, but instead can be multi-purpose machines, for example computer workstations, that are suitable for also performing other tasks. Furthermore the computers may use transitory and non-transitory forms of computer-readable media. Non-transitory computer-readable media is to be interpreted to comprise all computer-readable media, with the sole exception of being a transitory, propagating signal.

Interface 10 provides a communication link between external users, systems, and data sources and components of system 8. The interface 10 can be configured for allowing one or more users to input information to system 8 via any known input device. Examples can include a keyboard, mouse, touch screen, microphone, and/or any other desired input device. The interface 10 can be configured for allowing one or more users to receive information output from system 8 via any known output device. Examples can include a display monitor, a printer, a speaker, and/or any other desired output device. Interface 10 is configured to display data through a digital touch screen for example. Interface 10 can be configured for allowing other systems to communicate with system 8. For example, interface 10 can allow one or more remote computer(s) to access information, input information, and/or remotely instruct system 8 to perform one or more of the tasks described herein. Interface 10 can be configured for allowing communication with one or more remote data sources. For example, interface 10 can allow one or more remote data source(s) to access information, input information, and/or remotely instruct system 8 to perform one or more of the tasks described herein.

Sensing Module 22 is configured to read data from sensors 26, 28, 36 and transmit that data to logic module 18. Sensing module 22 is configured to turn the signal containing the data into a digital signal. Logic module 18 receives the signal from sensing module 22 and outputs that signal as needed. In so doing, logic module 18 acts as a central hub, or the main network interface, of the network defined within control module 11. Logic module 18 processes the data in the signal and performs calculations, data comparisons, and the storage of data. Based upon such calculations and comparisons, module 18 distributes commands to one or more other elements within control module 11. It is understood that one or more modules 18 may be used within control module 11.

Digital conversion module 16 receives and transmits command data between module 18 and interface 10. Module 16 includes a driver to convert information or command data to a digital display to use in interface 10. Additionally, module 16 is an interface used to convert from analog or semi-digital signals to a full digital signal to permit the formation of graphical data to display on interface 10.

Interface 10 is configured to notify a user concerning the performance of system 8 and to grant the user control of the various functions of system 8. Controls 12 are located on interface 10 to permit the user to adjust a display 14 and to access current and historical performance data along with other data stored in control module 11. Other data refers to data relevant to other functions of control module 11, such as when using sensors 36, when integrated into an irrigation system, or integrated with an alarm system, or even an air conditioning/heating system. Controls are illustrated as a plurality of buttons but it is understood that controls 12 may be any type of control that grants a user to input a selection into control module 11. For example: a button, a touch screen, a dial, an infrared sensor.

Notifications are provided by system 8 to alert the user to a discrepancy in fluid usage or other sensor 36 data. Notifications may be given in a number of different ways, such as through graphical symbols, audible communication, or other visual communication. Such notifications may be displayed or indicated on interface 10 or sent to a remote device via digital communication module 34. Additionally, a siren or alarm 32 may be sounded to provide audible notification.

Module 34 is in communication with module 18 and interface 10. Module 34 is configured to transmit notifications to a user via wired and/or wireless remote communications. Such communications may be to a cellular device, secondary computer system, or other electronic display device. Additionally, the type of communication sent by module 34 may be at least any of the following: messages, chimes, texts, emails, phone calls, or other types of communication. In the preferred embodiment, the user is able to use interface 10 to selectively adjust the type of communications received and which devices are used, so as to personalize the type of notification. System 8 is configured to work in a digital computer system and have internet capabilities to interface with other digital networks.

Output module 20 is an electronic device configured to receive communication from module 18 and send power to one or both of valves 30 and alarm 32. Alarm 32 can be an existing alarm system or may be a stand alone siren. Output module 20 is also configured to adjust valves 30 to selectively restrict fluid flow through the fluid lines. Valves 30 are located in communication with the fluid lines to permit system 8 to shut off fluid flow through the fluid lines. In the preferred embodiment, valve 30 is located at the point of entry of the fluid into the structure. Other embodiments will also locate a valve 30 at each point of use location. It is understood that valves 30 may be located at intermittent locations within the fluid lines between the point of use and the point of entry. When instances arise that system 8 detects a leak or registers readings above a preferred level, system 8 is configured to regulate the flow of fluid in the fluid lines to stop the leak. The act of regulating the flow of fluid may be performed by closing the valves to prevent any fluid flow beyond the valve or adjusting valve 30 to change the water pressure and/or flow rate of the fluid in the lines.

As stated above, system 8 is configured to continuously monitor fluid flow between a point of use sensor and a point of entry sensor to detect a leak. Control module 11 calculates the difference between fluid use at the point of use compared to the point of entry. Control module 11 is configured to regulate the fluid flow in the fluid lines when a leak has been detected or when the occurrence of an event happens. A user can program system 8 to automatically regulate fluid flow or can program system 8 to notify the user and grant the user functional control to regulate valves 30 in system 8.

With respect to detecting a leak within the fluid lines, sensors 24, 26, 28 continuously monitors the duration of fluid flow, the flow rate, and the amount of fluid at each sensor 24, 26, 28 to assist in detections of leaks downstream. System 8 compares the fluid flow at the point of use to that of the fluid flow at the point of entry. If the fluid flow at the point of entry is greater than the fluid flow at the point of use, then there is a leak in the fluid lines after point of entry sensor 24 and prior to sensor 26, 28.

If there is equal fluid flow at the point of entry and the point of use, but the duration of fluid flow or flow rate at the point of use exceed an approved level, then a potential leak is detected downstream of sensor 26, 28. System 8 is configured to identify the location of the sensor 26, 28 and/or the fluid use device that may be the potential leak. A user is able to program into module 11 what each sensor 24, 26, 28 is coupled to (water main, stove, water heater, faucet, toilet . . . ). Additionally a user is able to program approved levels at each sensor 26, 28.

Module 11 is configured to permit a user the ability to designate the fluid use device at each sensor 26, 28; the levels of approved use for each fluid use device; whether or not to send a notification; the type and method of notification; and whether or not module 11 is to automatically close a valve 30 with or without sending a notification. In this way, operation of module 11 is personalized to a specific user and sensor 26, 28, 36. It is understood that other customizations to make system 8 function according to the user's preference are contemplated. The above customizations are representative examples only.

System 8 is configured to isolate the leak to any section between two sensors 24, 26, 28 and/or to any point beyond sensor 24, 26, 28 (such as downstream). As seen in the above examples, system 8 is capable of determining whether a leak occurs in the fluid lines of a structure either after sensor 26, 28 and/or between sensor 24 and sensor 26, 28. If additional sensors 26, 28 are dispersed and located between the point of use and the point of entry then system 8 is configured to compare the fluid flow between the point of entry and additional sensors. This permits the location of potential leaks between the point of use and the point of entry may be identified with a greater accuracy.

In general, sensors 36 provide data to module 11 regarding the current levels of detection in the structure with respect to the type of sensor 36 used. For example, the level of carbon monoxide or smoke in the home. System 8 has preset approved levels for each type of reading made through sensor 36. System 8 compares the approved levels to that of the current levels. If the current levels exceed the approved levels, control module 11 is configured to selectively regulate the flow of fluid in the fluid lines. System 8 is configured to permit the user the ability to set the approved levels.

In way of example, in the event that gas is used in the home, any leak may be fatal. Time based approved uses alone may not be adequate protection for gas leaks. System 8 is configured to use sensors 36 that monitor gas based leaks into the structure. If sensor 36 detects the presence of a gas, module 11 calculates the current level and compares the current level to that of the approved level. If the current level exceeds the approved level then module 11 is configured to close a valve in communication with the gas to prevent the leak. In some embodiments, sensor 24 and/or sensor 26 may be closed to ensure the stop of the leak as gas may permeate through walls from within a structure and may not only be leaking at the point of use. As with sensors 26, 28, a user is permitted to personalize the approved levels if any, the type and method of communications and so forth. The approved levels of sensor 36 may be adjusted by system 8 and/or the user.

Control module 11 is configured to regulate the fluid flow in the fluid lines when the occurrence of an event happens. System 8 is configured to regulate the fluid flow in the fluid lines even when a leak in not detected. For example, during a fire in the home system 8 may be configured to shut off all the gas lines to prevent an accidental explosion. In another example, sensors 36 may detect a tornado, large storm, or earthquake through vibrations which can cause shifting or destruction of the structure. When in a destroyed or damaged state, fluid in the fluid lines may be ruptured and begin to leak; thereby causing flooding; with the potential for drowning those seeking refuge from the disaster; and/or create a gas leak leading to a potential explosion.

System 8 is configured to be installed within a structure during new build construction or as a retrofit. The various elements of system 8 may communicate wirelessly to aid in retrofit installations. The user is able to integrate and operate other systems in operation within the structure, such as security systems, irrigation systems, A/C and heating systems, and so forth. Another feature of system 8 is the ability of module 11 to store and analyze historical data. Module 11 is configured to analyze historical data pertaining to past fluid uses. Additionally, when integrated with other systems in the structure, module 11 analyzes historical data pertaining to each system. By analyzing historical data from each system and system 8, module 11 is configured to selectively adjust approved levels. The selective adjustment can be based on frequency of use, time of day, seasonal adjustments, for example.

The current application has many advantages over the prior art including the following: (1) detection of leaks by comparing the a point of use to a point of entry in the fluid lines; (2) ability to customize the type and method of notifications; (3) ability of system 8 to send notifications to a user in the event a leak is detected; (4) broad leak detection at any point along the fluid line as opposed to localized detection; (5) integration of the system with other residential or commercial systems; and (6) ability of the system to adjust current approved levels based upon historical use.

The particular embodiments disclosed above are illustrative only, as the application may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. It is apparent that an application with significant advantages has been described and illustrated. Although the present application is shown in a limited number of forms, it is not limited to just these forms, but is amenable to various changes and modifications without departing from the spirit thereof.

What is claimed is:

1. A system for detecting a leak in a fluid line, comprising:
a point of entry sensor configured to measure fluid flow within the fluid line entering a fluid system;
a point of use sensor configured to measure fluid flow exiting the fluid line within the fluid system; and
a control module in communication with the point of entry sensor and the point of use sensor to receive fluid flow data, the control module configured to compare the difference between approved fluid use at the point of use sensor to fluid use at the point of entry sensor, the control module configured to continuously monitor fluid flow entering and leaving the fluid system to detect the leak.

2. The system of claim 1, wherein the fluid is a liquid.

3. The system of claim 1, wherein the fluid is a gas.

4. The system of claim 1, wherein the control module is configured to regulate fluid flow within the fluid system by adjusting one or more valves.

5. The system of claim 4, wherein the one or more valves are located at the point of entry sensor to regulate fluid flow into the fluid system.

6. The system of claim 4, wherein the one or more valves are located at the point of use sensor to regulate fluid flow out of the fluid system through a fluid use device.

7. The system of claim 1, wherein the control module is configured to notify a user of the leak.

8. The system of claim 7, wherein the control module permits a user to selectively control the position of the valve to selectively regulate fluid flow.

9. The system of claim 1, wherein the point of use sensor is coupled between the fluid system and a fluid use device.

10. The system of claim 1, wherein the control module is in communication with at least one of a home alarm system, an irrigation system, and an air conditioning system.

11. The system of claim 1, wherein the control module interfaces with digital networks to permit wireless remote communications.

12. The system of claim 1, further comprising:
an auxiliary sensor remote to the fluid system and configured to be in communication with the control module.

13. The system of claim 12, wherein the auxiliary sensor detects the presence of at least one of airborne elements, noise, and vibrations adjacent and within a structure in communication with the fluid system.

14. The system of claim 1, wherein the control module is configured to analyze and compare historical use data and selectively adjust approved levels.

15. The system of claim 14, further comprising:
a second point of use sensor;
wherein the control module is programmable to permit varied levels of fluid flow between the first point of use sensor and the second point of use sensor.

16. A method of detecting leaks in a structure, comprising:
locating a point of entry sensor configured to measure fluid flow within a fluid line entering a fluid system;
locating a point of use sensor configured to measure fluid flow exiting the fluid line within the fluid system; and
continuously monitoring fluid flow entering and exiting the fluid system to detect the leak by comparing fluid use at the point of use sensor to fluid use at the point of entry sensor, the fluid flow through the point of entry sensor and the point of use sensor being monitored and regulated by a control module.

17. The method of claim 16, further comprising:
monitoring for the presence of at least one of an airborne element, noise, and vibration through an auxiliary sensor in communication with the control module, the at least one of an airborne element, noise, and vibration being adjacent and within the structure in communication with the fluid system;
calculating a current level of detection for the at least one of airborne elements, noise, and vibrations; and
comparing the current level of detection to an approved level;
wherein the control module selectively regulates fluid flow within the fluid system when the current level exceeds the approved level.

18. The method of claim 16, further comprising:
comparing actual fluid flow to an approved level of use; and
notifying a user when the actual fluid flow exceeds the approved level of use.

19. The method of claim 16, wherein the user
transmitting data from the control module through a digital communication module to permit wireless remote communication to a user.

20. The method of claim 16, wherein the control module is configured to provide at least one of historical data and current data through a user interface, the historical data and the current data are gathered from at least one of the point of entry sensor, the point of use sensor, and an auxiliary sensor.
